(19) United States
(12) Patent Application Publication
(10) Pub. No.: US 2011/0267138 A1
(43) Pub. Date: Nov. 3, 2011

(54) Synchronous rectifier circutits

(76) Inventor: Chao-Cheng Lu, Taipei (TW)

(21) Appl. No.: 12/799,733

(22) Filed: May 3, 2010

(51) Int. Cl. H02M 7/217

(52) U.S. Cl. 327/531

(57) ABSTRACT

This invention relates in Synchronous Rectifier Circuits, comprises: AC input terminal, switch, driving circuit, protect opposite current circuit and a load, to improved conventional Synchronous Rectifier Circuits, can be achieve rectify function.

### BACKGROUND OF THE INVENTION

1. Field of the Invention

The present invention related to enhancement mode power MOSFET or power JFET for synchronous rectifier, especially driving voltage connected to gate and drain of power MOSFET or power JFET replacing prior art driving voltage connected to gate and source of power MOSFET or power JFET.

According to such philosophy of the present invention, the synchronous rectifier may be achieved use power MOSFET or power JFET, driving circuit, and protect opposite current circuit. Hence, functions of minimizing voltage drop between Alternating Current (AC) and Direct Current (DC) voltage output to load of the synchronous rectifier may be achieved.

2. Description of Related Art

As shown in FIG. 1 is a circuit diagram of a prior art high efficiency regulate DC supply, which had been illustrated by U.S. Pat. No. 5,038,266. The circuit uses power MOSFET 22 and 23 to be the switch of rectifying and voltage regulation, transforms the DC power to the load terminal 18. Such scheme comes with the following drawbacks:

(1) To use the gate-source electrodes of the power MOSFET 22, 23 as input of high frequency power supply, the value of the input capacitance is large than that oft he output capacitance, which cannot downsize the power supply, therefore the power MOSFET is not suitable for the high frequency power supply.
(2) The maximum ratings between the gate and source of a normal power MOSFET are ±20V, the surge voltage at the secondary windings of the high frequency transformer will bum the gate-source of the power MOSFET out.
(3) When the voltage at the source 20 of the power MOSFET 15 is a high frequency positive voltage, input capacitance value at the gate-source is greater, the high frequency positive voltage will turn the source 20, the gate 25, the diode 39 and the resistor 43 into short, therefore, the power MOSFET 22 is easy to be burned out.

When the DC voltage potential at the drain 21 of the power MOSFET 22, 23 is greater than that at the source 20, the high frequency power will cause great DC short current at turn-on delay time or turn-off delay time to burn the power MOSFET 22, 23 and the secondary winding 13, 14 of the power supply out.

### SUMMARY OF THE INVENTION

In order to provide DC power supply device, which may elevate the efficiency of rectification, this invention is accordance with the following objects.

The first object of this invention is to provide driving voltage connected to the gate and drain of power MOSFET, can be eliminate the burnout of prior art power MOSFET and used in the high frequency power system.

The second object of the present invention, is a driving voltage connected to the gate and drain of power MOSFET, can be eliminate the drawback of high power consumption of prior art rectifier utilizing diode.

According to the defects of the prior art technology discussed above, a novel solution, is a driving voltage connected to the gate and drain of power MOSFET is propose in the present invention, which provides higher efficiency in rectifier.

### BRIEF DESCRIPTION OF THE DRAWINGS

FIG. 1 is a circuit diagram of a prior art high efficiency regulate DC supply.

FIG. 2 is a circuit diagram of an N-Channel FET.

FIG. 3 is a circuit diagram of first embodiment of the present invention.

FIG. 4 is a circuit diagram of second embodiment of the present invention.

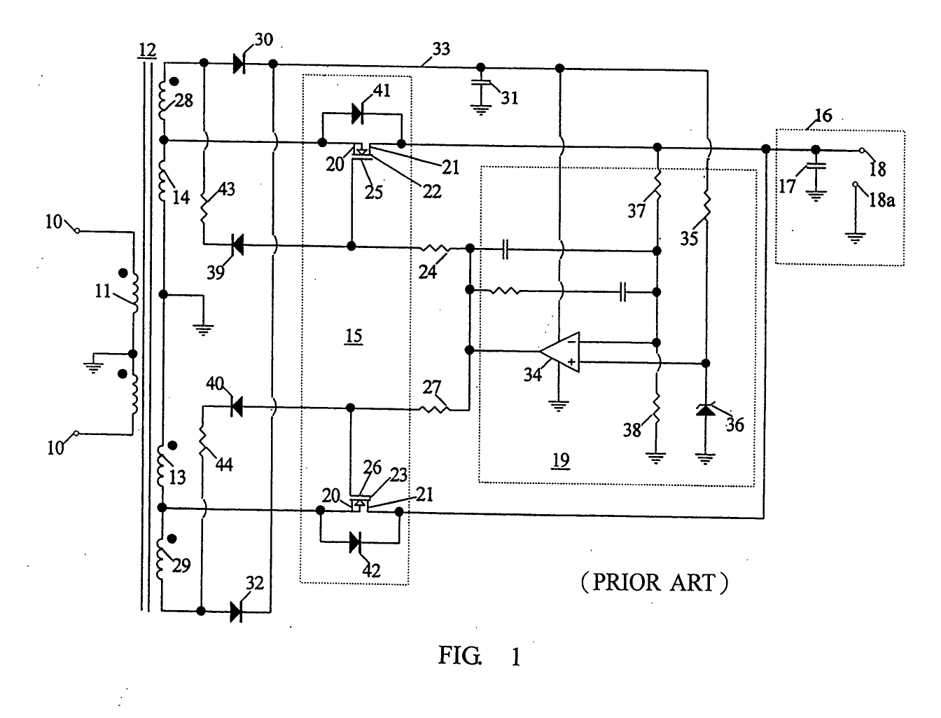

### DETAILED DESCRIPTION OF THE PREFERRED EMBODIMENTS

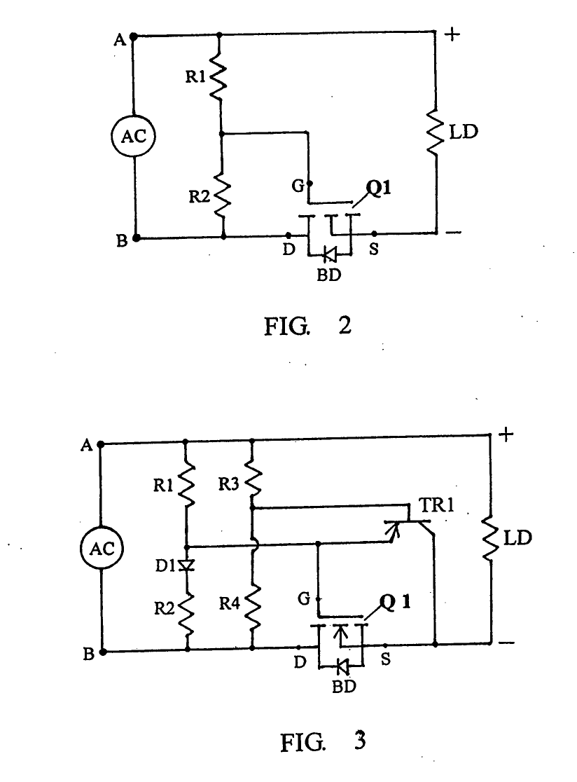

As shown in FIG. 2, has an AC power source input terminal, a first terminal A and second terminal B of the input terminal, a N-Channel FET Q1, a first driving element R1, a second driving element R2 and a load LD.

A body diode BD in the N-Channel FET Q1 shown in FIG. 2, a driving circuit comprises a first driving element R1 and a second driving element R2; the first terminal of first driving element R1 connected to terminal A of AC power source and first terminal of load LD, the second terminal of first driving element R1 connected to first terminal of the second driving element R2 and connected together to gate of the N-Channel FET Q1, the second terminal of the second driving element R2 connected to drain of the N-Channel FET Q1 and terminal B of AC power source; source of the N-Channel FET Q1 connected to second terminal of load LD; the driving voltage is equal to the second driving element R2 two terminal voltage drop.

As shown in FIG. 2, when positive of AC power source in the terminal A, terminal B is negative, the first terminal of the second driving element R2 is positive, second terminal of the second driving element R2 is negative, the N-Channel FET Q1 is turned on, the driving voltage is equal to the voltage drop resistor R2, the path of the current flows is from terminal A of the AC power source though a load LD, source-drain of N-Channel FET Q1, and back to terminal B of the AC power source.

As shown in FIG. 2, when negative of AC power source in the terminal A, terminal B is positive, the first terminal of the second driving element R2 is negative, second terminal of the second driving element R2 is positive, the N-Channel FET Q1 is turned off, the rectifier is open circuit.

As shown in FIG. 3, the operation principle of the second driving element comprises a diode D1 and resistor R2, the P-junction of diode D1 connected to gate of the N-Channel FET Q1, the N-junction of diode D1 connected to first terminal of resistor R2, second terminal of second driving element connected to drain of the N-Channel FET Q1 and second terminal of AC power source, the driving voltage is equal to forward voltage of diode D1 and resistor R2 drop voltage; the operation of the resistor R2 the function of zener diode is same, both of the resistor R2 can be use a zener diode replace, the driving voltage is equal to forward voltage D1 and zener voltage of zener diode; the protect opposite current circuit comprises a voltage dividing resistor R3, R4 and a transistor TR1, first terminal of the first voltage dividing resistor R3 connected to terminal A of AC power source and first terminal of load LD, second terminal of first voltage dividing resistor R3 and first terminal of second voltage dividing resistor R4 connected together to base of transistor TR1, second terminal of second voltage dividing resistor R4 connected to terminal B of AC power source and drain of the N-Channel FET Q1, emitter of the transistor TR1 connected to gate of the N-Channel FET Q1, second terminal of first driving element R1 and P-junction of diode D1 connected together to emitter of transistor TR1 and gate of the N-Channel FET Q1; collector of the transistor TR1 connected to source of the N-Channel FET Q1 and second terminal of load LD.

As shown in FIG. 3, when positive of AC power source in the terminal A, terminal B is negative, the first terminal of second voltage dividing resistor R4 is positive, the second terminal of second voltage dividing resistor R4 is negative, the transistor TR1 is turned off, collector and emitter of the transistor TR1 is open circuit, the path of the current flows is from terminal A of the AC power source though a load LD, source-drain of N-Channel FET Q1 and back to terminal B of the AC power source.

As shown in FIG. 3, when negative of AC power source in the terminal A, terminal B is positive, the first terminal of second voltage dividing resistor R4 is negative, the second terminal of second voltage dividing resistor R4 is positive, the transistor TR1 is turned on, collector and emitter of the transistor TR1 is short circuit, the rectifier is open circuit.

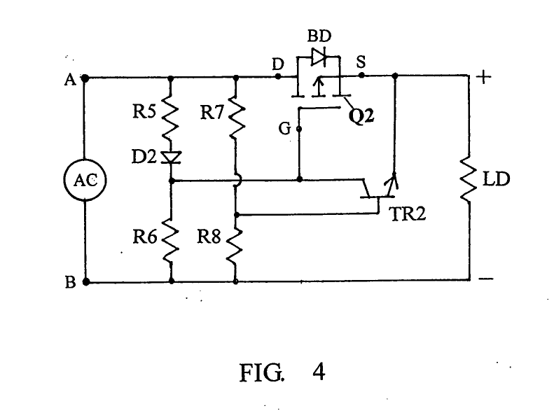

As shown in FIG. 4, the operation principle of the first driving element comprises a diode D2 and resistor R5, the N-junction of diode D2 connected to gate of the P-Channel FET Q2, the P-junction of diode D2 connected to second terminal of resistor R5, first terminal of resistor R5 connected to drain of the P-Channel FET Q2 and first terminal of AC power source, the driving voltage is equal to forward voltage of diode D2 and resistor R5 drop voltage; the operation of the resistor R5 the function of zener diode is same, both of the resistor R5 can be use a zener diode replace, the driving voltage is equal to forward voltage D2 and zener voltage of zener diode; the protect opposite current circuit comprises a voltage dividing resistor R7, R8 and a transistor TR2, first terminal of the first voltage dividing resistor R7 connected to terminal A of AC power source and drain of the P-Channel Q2, second terminal of first voltage dividing resistor R7 and first terminal of second voltage dividing resistor R8 connected together to base of transistor TR2, second terminal of second voltage dividing resistor R8 connected to terminal B of AC power source and second terminal of load LD, first terminal of second driving element R6 and N-junction of diode D2 and gate of the P-Channel FET Q2 connected together to collector of transistor TR2, emitter of the transistor TR2 connected to source of the P-Channel FET Q2 and first terminal of load LD, second terminal of second driving element R6 connected to terminal B of AC power source.

As shown in FIG. 4, when positive of AC power source in the terminal A, terminal B is negative, the first terminal of first voltage dividing resistor R7 is positive, the second terminal of first voltage dividing resistor R7 is negative, the transistor TR2 is turned off, collector and emitter of the transistor R2 is open circuit, the path of the current flows is from terminal A of the AC power source though drain-source of P-Channel FET Q2, a load LD and back to terminal B of the AC power source.

As shown in FIG. 4, when negative of AC power source in the terminal A, terminal B is positive, the first terminal of first voltage dividing resistor R7 is negative, the second terminal of first voltage dividing resistor R7 is positive, the transistor TR2 is turned on, collector and emitter of the transistor R2 is short circuit, the rectifier is open circuit.

What is claimed is:

1. A synchronous rectifier circuits, comprises:
a first driving element for voltage drop;
a second driving element for driving gate-drain of N-Channel FET;
a protect opposite current circuit; and
a N-Channel FET; can be achieve rectify function.

2. A synchronous rectifier circuits as in claim 1, wherein:
said first driving element comprise a resistor.

3. A synchronous rectifier circuits as in claim 1, wherein:
said a second driving element comprise a diode and a resistor or a diode and a zener diode.

4. A synchronous rectifier circuits as in claim 1, wherein:
said second terminal of a first driving element and first terminal of a second driving element connected together to said gate of the N-Channel FET.

5. A synchronous rectifier circuits as in claim 1, wherein:
said second terminal of second driving element connected to second of AC power source input terminal and said drain of the N-Channel FET.

6. A synchronous rectifier circuits as in claim 1, wherein:
said protect opposite current circuit comprises a voltage diving resistor and a transistor.

7. A synchronous rectifier circuits as in claim 1, wherein:
said second terminal of first voltage dividing resistor and first terminal of second voltage dividing resistor connected together to base of transistor.

8. A synchronous rectifier circuits as in claim 1, wherein:
said emitter of transistor connected to gate of the N-Channel FET.

9. A synchronous rectifier circuits as in claim 1, wherein:
said collector of transistor connected to source of the N-Channel FET.

10. A synchronous rectifier circuits as in claim 1, wherein:
said positive of AC power source in the terminal connected to drain of the N-Channel FET, can be achieve gate and source of the N-Channel FET short circuit.

11. A synchronous rectifier circuits, comprises:
a second driving element for voltage drop;
a first driving element for driving gate-drain of P-Channel FET;
a protect opposite current circuit; and
a P-Channel FET; can be achieve rectify function.

12. A synchronous rectifier circuits as in claim 11, wherein:
said second driving element comprise a resistor.

13. A synchronous rectifier circuits as in claim 11, wherein:
said a first driving element comprise a diode and a resistor or a diode and a zener diode.

14. A synchronous rectifier circuits as in claim 11, wherein:
said second terminal of a first driving element and first terminal of a second driving element connected together to said gate of the P-Channel FET.

15. A synchronous rectifier circuits as in claim 11, wherein:
said first terminal of first driving element connected to first of AC power source input terminal and said drain of the P-Channel FET.

16. A synchronous rectifier circuits as in claim 11, wherein:
said protect opposite current circuit comprises a voltage diving resistor and a transistor.

17. A synchronous rectifier circuits as in claim 11, wherein:
said second terminal of first voltage dividing resistor and first terminal of second voltage dividing resistor connected together to base of transistor.

18. A synchronous rectifier circuits as in claim 11, wherein:
said emitter of transistor connected to source of the P-Channel FET.

19. A synchronous rectifier circuits as in claim 11, wherein:
said collector of transistor connected to gate of the P-Channel FET.

20. A synchronous rectifier circuits as in claim 11, wherein:
said negative of AC power source in the terminal connected to drain of the P-Channel FET, can be achieve gate and source of the P-Channel FET short circuit.
